(19) United States
(12) Patent Application Publication
(10) Pub. No.: US 2009/0088957 A1
(43) Pub. Date: Apr. 2, 2009

(54) Control apparatus for internal combustion engine and method for controlling the same

(75) Inventors: Eijirou Yamada, Hekinan-city (JP); Yasuo Hirata, Chita-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/232,768

(22) Filed: Sep. 24, 2008

(30) Foreign Application Priority Data
Oct. 2, 2007 (JP) 2007-258310

(51) Int. Cl. F02D 45/00

(52) U.S. Cl. 701/111

(57) ABSTRACT

A knock determination unit is configured to determine whether the internal combustion engine causes knocking. A knock control unit is configured to perform a knock control to correct an ignition timing on the basis of the determination. A water pump is configured to circulate cooling fluid of the internal combustion engine. A pump control unit is configured to perform a cooling control to control the water pump so as to further cool the internal combustion engine in a detection state, where the knock determination unit detects knocking, than in a non-detection state where the knock determination unit does not detect knocking.

### CROSS REFERENCE TO RELATED APPLICATIONS

This application is based on and incorporates herein by reference Japanese Patent Application No. 2007-258310 filed on Oct. 2, 2007.

### FIELD OF THE INVENTION

The present invention relates to a control apparatus for an internal combustion engine configured to correct an ignition timing on the basis of a determination of occurrence of knocking in the internal combustion engine. The present invention relates to a method for controlling the same.

### BACKGROUND OF THE INVENTION

In general, an internal combustion engine controls an ignition timing at a target ignition timing such as a minimum advance for best torque MBT, in which torque is most effectively produced, so as to effectively produce torque, thereby reducing fuel consumption. However, in the present control, knocking may occur in the internal combustion engine depending on a driving state, fuel properties, or the like. For example, in US 2007/0012090 A1 (JP-A-2007-9814), a knock sensor is provided to an internal combustion engine for detecting a knocking vibration of the internal combustion engine. In the present structure, knock level determined from the output signal of the present knock sensor is compared with a knock threshold to determine whether knocking occurs. When knocking is detected, an ignition timing is corrected and delayed to suppress the knocking. Alternatively, when knocking is not detected, a knock control is performed for correcting and advancing the ignition timing. The ignition timing is advanced as much as possible within a range in which the knocking can be suppressed so as to improve fuel consumption in the present conventional knock control. However, in the present conventional knock control described above, knocking is suppressed only by correcting and delaying the ignition timing, and hence the correction quantity of delay in the ignition timing becomes large. Thus, the present conventional control raises a problem that the efficiency of producing torque may be decreased, and fuel consumption may not be sufficiently enhanced.

### SUMMARY OF THE INVENTION

In view of the foregoing and other problems, it is an object of the present invention to produce a control apparatus for an internal combustion engine, the apparatus configured to reduce a correction quantity of delay in ignition timing while suppressing knocking. It is another object of the present invention to produce a method for controlling the internal combustion engine.

According to an aspect of the present invention, a control apparatus for an internal combustion engine, the control apparatus comprises knock determination means for determining whether the internal combustion engine causes knocking. The control apparatus further comprises knock control means for performing a knock control to correct an ignition timing on the basis of the determination. The control apparatus further comprises a water pump configured to circulate cooling fluid of the internal combustion engine. The control apparatus further comprises pump control means for performing a cooling control to control the water pump so as to further cool the internal combustion engine in a detection state, where the knock determination means detects knocking, than in a non-detection state where the knock determination means does not detect knocking.

According to another aspect of the present invention, a control apparatus for an internal combustion engine, the control apparatus comprises knock determination means for determining whether the internal combustion engine causes knocking. The control apparatus further comprises knock control means for performing a knock control to correct an ignition timing on the basis of the determination. The control apparatus further comprises a water pump configured to circulate cooling fluid of the internal combustion engine. The control apparatus further comprises region determination means for determining whether a driving state of the internal combustion engine is in a region where the internal combustion engine has a potential to cause knocking. The control apparatus further comprises pump control means for performing a cooling control to control the water pump so as to further cool the internal combustion engine in response to a determination of the region determination means that the driving state is in the region than when the driving state is out of the region.

According to another aspect of the present invention, a control apparatus for an internal combustion engine, the control apparatus comprises knock determination means for determining whether the internal combustion engine causes knocking. The control apparatus further comprises knock control means for correcting an ignition timing of the internal combustion engine on the basis of the determination. The control apparatus further comprises cooling fluid control means for increasing an amount of cooling fluid fed to cool the internal combustion engine in response to determination of the knock determination means that the internal combustion engine causes knocking.

According to another aspect of the present invention, a control apparatus for an internal combustion engine, the control apparatus comprises knock determination means for determining whether the internal combustion engine causes knocking. The control apparatus further comprises knock control means for correcting an ignition timing on the basis of the determination. The control apparatus further comprises region determination means for determining whether a driving state of the internal combustion engine is in a region where the internal combustion engine causes knocking. The control apparatus further comprises cooling fluid control means for increasing an amount of cooling fluid fed to cool the internal combustion engine in response to determination of the region determination means determines that the driving state is in the region.

According to another aspect of the present invention, a method for controlling an internal combustion engine, the method comprises determining whether the internal combustion engine causes knocking. The method further comprises correcting an ignition timing of the internal combustion engine on the basis of the determination. The method further comprises increasing an amount of cooling fluid fed to cool the internal combustion engine in response to a determination that the internal combustion engine causes knocking.

According to another aspect of the present invention, a method for controlling an internal combustion engine, the method comprises determining whether the internal combustion engine causes knocking. The method further comprises correcting an ignition timing on the basis of the determination. The method further comprises determining whether a driving state of the internal combustion engine is in a region where the internal combustion engine causes knocking. The method further comprises increasing an amount of cooling fluid fed to cool the internal combustion engine in response to a determination that the driving state is in the region.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing an engine cooling system according to an embodiment;

FIG. 2 is a time chart showing a an in-warming-up cooling control of the engine;

FIG. 3 is a time chart showing a post-warming-up cooling control of the engine;

FIG. 4 is a flow chart showing a first processing of a water pump control; and

FIG. 5 is a flow chart showing a second processing of the water pump control.

### DETAILED DESCRIPTION OF PREFERRED EMBODIMENTS

### Embodiment

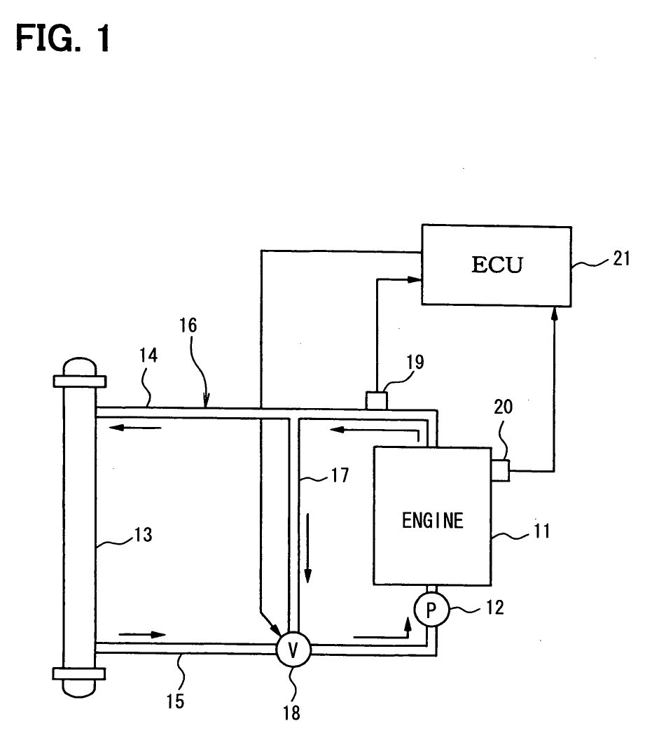

First, the general construction of an entire engine cooling system will be described with reference to FIG. 1.

An electric water pump 12 is provided at the inlet of a cooling water passage (water jacket) of an engine 11 of an internal combustion engine. The outlet of the cooling water passage of the present engine 11 is connected to the inlet of a radiator 13 via a cooling water circulation pipe 14. The outlet of the radiator 13 is connected to the suction port of the water pump 12 via a cooling water circulation pipe 15. In the present structure, a cooling water circulation circuit 16 is constructed. In the cooling water circulation circuit 16, cooling water is circulated through a path including the cooling water passage of the engine 11, the cooling water circulation pipe 14, the radiator 13, the cooling water circulation pipe 15, the water pump 12, and the cooling water passage of the engine 11 in this order.

The present cooling water circulation circuit 16 has a bypass channel 17 provided parallel to the radiator 13. Both ends of the bypass channel 17 are connected to the middle portions of the cooling water circulation pipes 14, 15. A channel switching valve 18 is provided at the confluence of the bypass channel 17 and the cooling water circulation pipe 15. The present channel switching valve 18 is constructed of a solenoid valve configured to switch between a channel for circulating the cooling water from the engine 11 to only the bypass channel 17 and a channel for circulating the cooling water to only the radiator 13 from the engine 11.

Moreover, the cooling water circulation pipe 14 on the cooling water outlet side of the engine 11 is provided with a cooling water sensor 19 for detecting the temperature of the cooling water (cooling fluid). The cylinder block of the engine 11 is provided with a knock sensor 20 for detecting knocking vibration.

The outputs of these various kinds of sensors are inputted to a control circuit (ECU) 21. The present ECU 21 is mainly constructed of a microcomputer for executing various engine control programs stored in a built-in ROM (storage medium) to control the fuel injection quantity of a fuel injection valve (not shown) and the ignition timing of an ignition plug (not shown) according to the driving state of the engine.

In the present operation, the ECU 21 functions as knock determination means for comparing knock level, knock frequency, and the like, which are determined based on the output signal of the knock sensor 20, with corresponding thresholds so as to determine whether knocking occurs. Thus, the ECU 21 causes to perform a knock control for correcting an ignition timing on the basis of the determination result. In the present knock control, when knocking is detected, the ignition timing is corrected and delayed in the present knock detection state, whereby the knocking is suppressed. When knocking is not detected, the ignition timing is corrected and advanced in the present knock non-detection state, so that the correction quantity of delay in the ignition timing is decreased. In the present operation, the ignition timing is advanced as much as possible in a range in which knocking is restricted, thereby being brought close to a target ignition timing such as optimum ignition timing to generate minimum advance for best torque (MBT).

Moreover, the ECU 21 performs a normal control before the warming-up of the engine is completed. Specifically, before the completion of warming-up, the driving current of the water pump 12 is controlled at a normal current value in a state where the channel switching valve 18 selects the channel for circulating the cooling water through only the bypass channel 17 from the engine 11. For example, in the state before the completion of warming-up, the driving current of the water pump 12 is controlled at a minimum driving current required to restrict the vicinity of the cylinder of the engine 11 from being brought into a locally overheated state. In the present structure, the water pump 12 is operated at low speed to decrease the circulation speed of the cooling water so as to accelerate the warming-up of the engine 11. In this regard, the water pump 12 may be maintained in a stop state before the completion of warming-up. Alternatively, the water pump 12 may be rotated intermittently to circulate the cooling water at low speed.

After the warming-up of the engine is completed, the ECU 21 performs a normal control. Specifically, after the completion of warming-up, the rotation speed of the water pump 12 is feedback controlled so as to control an actual cooling water temperature, which is detected by the cooling water temperature sensor 19, at a normal target cooling water temperature in a range where 80° C. and 90° C., for example. In the present state, the channel switching valve 18 selects a channel for circulating the cooling water through only the radiator 13 from the engine 11, after the completion of warming-up. In the present structure, the actual cooling water temperature is maintained close to the normal target cooing water temperature after the completion of warming-up of the engine.

Further, when knocking (knock) is detected, the ECU 21 performs a knock restriction cooling control for controlling the water pump 12 so as to cool the engine 11 more strongly compared with a condition where knocking is not detected. When knocking is detected, the ECU 21 performs the knock control to delay the ignition timing and further performs the cooling control to cool the cylinder of the engine 11 more strongly compared with the condition where the knocking is not detected. Whereby, the spontaneous ignition of air-fuel mixture, which causes knocking, can be restricted, and hence knocking can be restricted. The knock restriction effect produced by the cooling control can restrict knocking in a state where the correction quantity of delay in the ignition timing is further reduced compared with the conventional operation. Therefore, in the present structure, the correction quantity of delay in the ignition timing produced by the knock control can be reduced compared with the conventional operation. Therefore, the ignition timing can be brought close to the target ignition timing, or the correction quantity of delay in the ignition timing in the knock control can be made null in the control of the ignition timing at the target ignition timing.

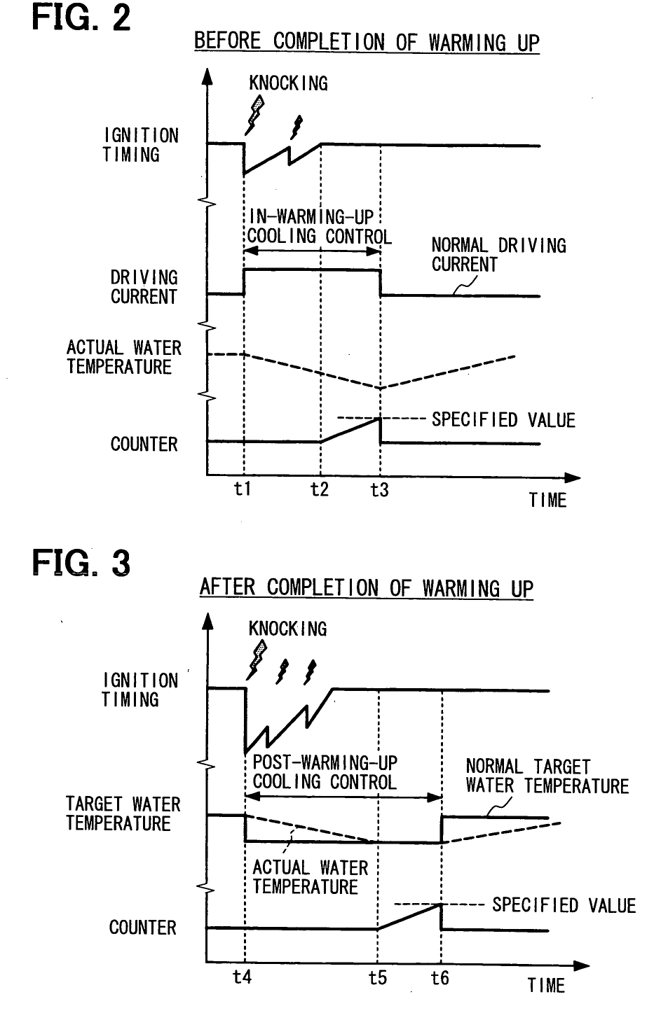

Specifically, as shown in FIG. 2, when the knocking is detected at the timing t1 before the warming-up of the engine is completed, the control of the water pump 12 is switched from an in-warming-up normal control before the completion of warming-up to an in-warming-up cooling control before the completion of the warming up. The in-warming-up normal control is performed for accelerating the warming-up of the engine 11.

In the in-warming-up normal control, the driving current of the water pump 12 is controlled at an in-warming-up normal current value before the completion of warming-up to operate the water pump 12 at low speed to decrease the circulation speed of the cooling water. In the present operation, the warming-up of the engine 11 is accelerated while the effect of cooling the engine 11 is reduced. Accordingly, the temperature of the cooling water near the cylinder of the engine 11 is apt to become higher than the temperature of the cooling water of the other portion.

In contrast, in the in-warming-up cooling control, the driving current of the water pump 12 is controlled at a current value larger than the in-warming-up normal current value by a specified correction quantity of current. Therefore, the rotation speed of the water pump 12 is increased, thereby the circulation speed of the cooling water is increased. The present in-warming-up cooling control can accelerate the mixing of the cooling water near the cylinder with the cooling water of the other portion to decrease the temperature of the cooling water near the cylinder. The present operation can further cool the cylinder than the operation when the knocking is not detected, and hence knocking can be restricted. By the present knock restriction effect produced by the in-warming-up cooling control, the correction quantity of delay in the ignition timing in the knock control can be reduced compared with the conventional operation. Thus, the ignition timing can be brought close to the target ignition timing, or the correction quantity of delay in the ignition timing in the knock control can be made null to control the ignition timing at the target ignition timing.

After the present in-warming-up cooling control is stated, at the timing t2 when the correction quantity of delay in the ignition timing in the knock control becomes a specified value (for example, zero) or less, the time counting operation of a counter is started. The time counting operation of the counter is conducted for measuring the duration of the state where the correction quantity of delay in the ignition timing is the specified value or less. At the timing t3 when the count value of the counter becomes larger than a specified value, the in-warming-up cooling control is terminated and is returned to the in-warming-up normal control.

As shown in FIG. 3, when knocking occurs after the completion of warming-up of the engine at the timing t4, the control of the water pump 12 is switched from a post-warming-up normal control after completion of warming-up to a post-warming-up cooling control after completion of warming-up. In the post-warming-up normal control, an actual cooling water temperature is controlled at a value close to a post-warming-up normal target water temperature after the completion of warming-up.

In the present post-warming-up cooling control, the rotation speed of the water pump 12 is feedback controlled so as to set a target water temperature lower than the post-warming-up normal target water temperature by a specified correction quantity of water temperature. Thus, the actual cooling water temperature is controlled at the target water temperature lower than the post-warming-up normal target water temperature. In the present operation, the engine 11 can be more strongly cooled than when knocking is not detected, whereby the knocking can be restricted. By the knock restriction effect produced by the post-warming-up cooling control, the correction quantity of delay in the ignition timing in the knock control can be reduced compared with the conventional operation. Hence the ignition timing can be brought close to the target ignition timing, or the correction quantity of delay in the ignition timing can be made null to control the ignition timing to the target ignition timing.

After the post-warming-up cooling control is started, at the timing t5 when the correction quantity of delay in the ignition timing in the knock control becomes a specified value (for example, zero) or less and when the actual cooling water temperature becomes nearly equal to the target water temperature, the time counting operation of the counter is started. The time counting operation of the counter is conducted for measuring the duration of a state where the correction quantity of delay in the ignition timing is the specified value or less and where the actual cooling water temperature is nearly equal to the target water temperature. At the timing t6 when the count value of the present counter becomes larger than a specified value, the post-warming-up cooling control is terminated and is returned to the post-warming-up normal control.

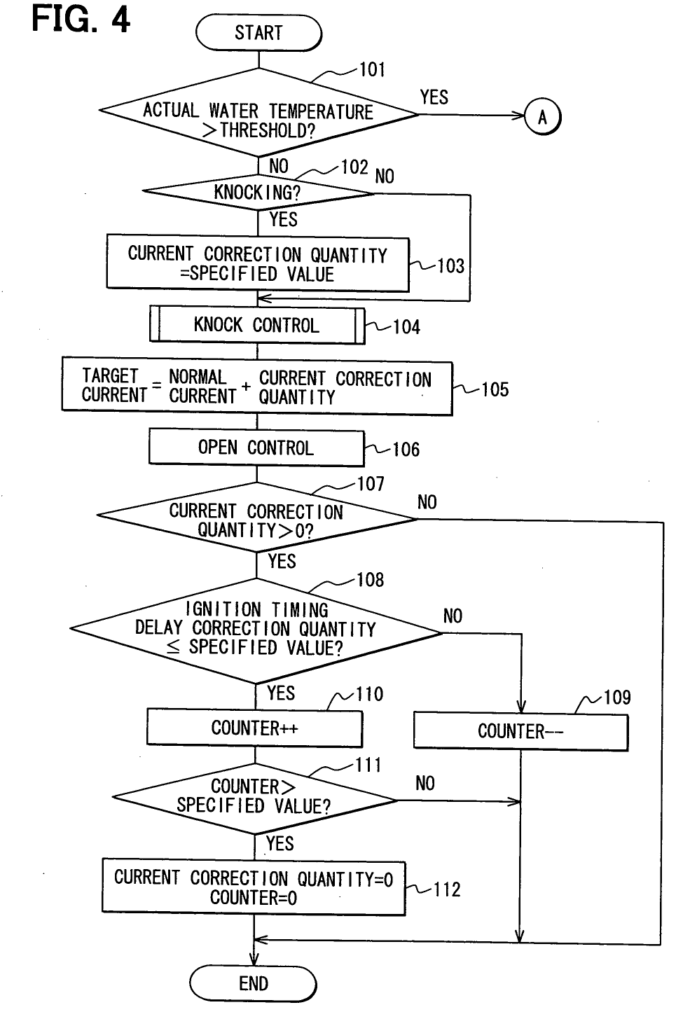

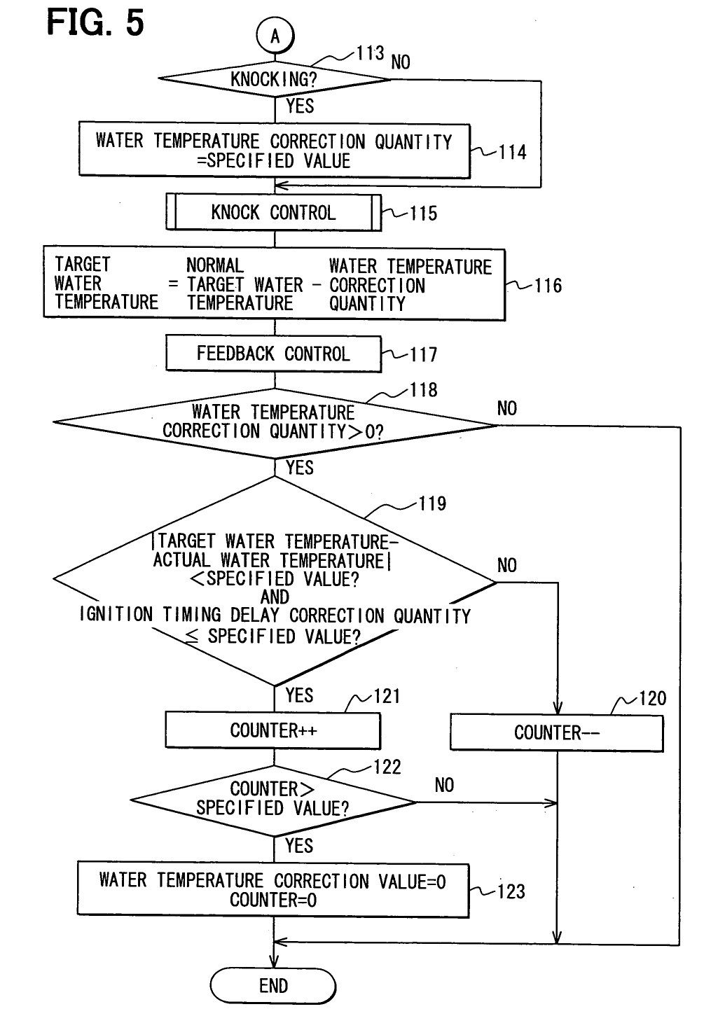

The water pump control described above is performed by the ECU 21 according to the respective routines shown in FIG. 4 and FIG. 5. Hereinafter, the processing contents of the respective routines will be described.

The water pump control routine shown in FIG. 4 and FIG. 5 is performed at specified intervals while the power of the ECU 21 is on and acts as water pump control means (cooling fluid control means). When the present routine is started, first, in step 101, the ECU 21 determines whether the warming-up of the engine is completed by determining whether the actual cooling water temperature detected by the cooling water temperature sensor 19 is higher than a specified temperature (for example, 80° C.).

When it is determined at present step 101 that the warming-up of the engine is not yet completed since the actual cooling water temperature is not larger than the specified temperature, the routine proceeds to step 102. At step 102, knock level, knock frequency, and the like detected from the output signal of the knock sensor 20 are compared with corresponding thresholds to determine whether knocking occurs.

When it is determined at present step 102 that knocking occurs, the routine proceeds to step 103 where the correction quantity (current correction quantity) of current, by which the target driving current of the water pump 12 is increased, is set at a specified value (>0). In this case, the current correction quantity may be set in advance at a fixed value to simplify the processing. Alternatively, the current correction quantity may be changed according to the driving state including rotation speed, load, and the like of the engine.

Thereafter, the routine proceeds to step 104 where the knock control is performed. In the present processing, when knocking is detected, the ignition timing is corrected and delayed to restrict the knocking, and when knocking is not detected, the correction quantity of delay angle is decreased, and the ignition timing is corrected and advanced.

Subsequently, the routine proceeds to step 105 where the current correction quantity is added to the in-warming-up normal current value to obtain a target driving current.

Target driving current=normal current value+current correction quantity

Subsequently, the routine proceeds to step 106 where the driving current of the water pump 12 is controlled at the target driving current in a state where the channel for circulating the cooling water to only the bypass channel 17 from the engine 11 is selected by the channel switching valve 18. In the present operation, when the current correction quantity is reset to zero, the in-warming-up normal control that controls the driving current of the water pump 12 at the target driving current (=normal current value) is performed. On the other hand, when the current correction quantity is set to the specified value, the in-warming-up cooling control that controls the driving current of the water pump 12 at the target driving current (=normal current value+current correction quantity) is performed.

Subsequently, the routine proceeds to step 107 where it is determined whether the in-warming-up cooling control is being performed by determining whether the current correction quantity is larger than zero. When it is determined that the current correction quantity is zero or less, and the in-warming-up cooling control is determined to be not being performed, the present routine is terminated without performing any more processing.

Subsequently, when it is determined in step 107 that the current correction quantity is larger than zero, and the in-warming-up cooling control is determined to be performed, the routine proceeds to step 108 where it is determined whether the correction quantity of delay in the ignition timing in the knock control is a specified value (for example, zero) or less. When it is determined that the correction quantity (ignition timing delay correction quantity) of delay in the ignition timing in the knock control is larger than the specified value, the routine proceeds to step 109. At step 109, the count value of the counter, which is for measuring the duration of a state where the correction quantity of delay in the ignition timing is the specified value or less, is decremented.

On the other hand, when it is determined in the step 108 that the correction quantity of delay in the ignition timing in the knock control is the specified value or less, the routine proceeds to step 110 where the count value of the counter is incremented. Subsequently, the routine proceeds to step 111 where it is determined whether the count value of the counter is larger than a specified value. When it is determined that the count value of the counter is larger than the specified value, the routine proceeds to step 112 where the current correction quantity is reset to zero, and the in-warming-up cooling control is terminated and is returned to the in-warming-up normal control, and the count value of the counter is reset to zero.

In contrast, when it is determined at step 101 that the actual cooling water temperature is higher than the specified temperature, and the warming-up of the engine is already completed, the routine proceeds to step 113 shown in FIG. 5. At step 113, knock level, knock frequency, and the like detected from the output signal of the knock sensor 20 are compared with corresponding thresholds to determine whether knocking occurs.

When it is determined at present step 113 that knocking occurs, the routine proceeds to step 114 where the correction quantity (water temperature correction quantity) of water temperature, by which a target water temperature is decreased, is set at a specified value (>0). The correction quantity of water temperature may be set in advance at a fixed value to simplify the processing. Alternatively, the correction quantity of water temperature may be changed according to the driving state including the rotation speed, the load, and the like of the engine.

Thereafter, the routine proceeds to step 115 where the knock control is performed. In the present processing, when knocking is detected, the knock control is performed to correct and delay the ignition timing to restrict the knocking. When knocking is not detected, the ignition timing is corrected and advanced, whereby the correction quantity of delay angle is decreased.

Subsequently, the routine proceeds to step 116 where the correction quantity (water temperature correction quantity) of water temperature is subtracted from the post-warming-up normal target water temperature (for example, 80° C. to 90° C.) to obtain a target water temperature.

Target water temperature=normal target water temperature−correction quantity of water temperature

Subsequently, the routine proceeds to step 117 where the water pump 12 is feedback controlled so as to control the actual cooling water temperature detected by the cooling water temperature sensor 19 at the target water temperature in the state where the channel for circulating the cooling water to only the radiator 13 from the engine 11 is selected by the channel switching valve 18. In the present operation, when the correction quantity of water temperature is reset to zero, the post-warming-up normal control is performed to feedback control the rotation speed of the water pump 12 so as to control the actual cooling water temperature at the target water temperature (=normal target water temperature). On the other hand, when the correction quantity of water temperature is set to the specified value, the post-warming-up cooling control is performed to feedback control the rotation speed of the water pump 12 so as to control the actual cooling water temperature at the target water temperature (=normal water temperature−correction quantity of water temperature).

Subsequently, the routine proceeds to step 118 where whether the post-warming-up cooling control is being performed is determined by determining whether the correction quantity of water temperature is higher than zero. When it is determined that the correction quantity of water temperature is zero or less, and the post-warming-up cooling control is determined to be not performed, the present routine is terminated without performing any more processing.

Subsequently, when it is determined in the step 118 that the correction quantity of water temperature is higher than zero, and the post-warming-up cooling control is determined to be performed, the routine proceeds to step 119. At step 119, it is determined whether the absolute value of the difference between the actual cooling water temperature and the target water temperature is smaller than a specified value (the actual cooling water temperature is nearly equal to the target water temperature) and where it is determined whether the correction quantity (ignition timing delay correction quantity) of delay in the ignition timing in the knock control is a specified value (for example, zero) or less.

When it is determined at present step 119 that the absolute value of the difference between the actual cooling water temperature and the target water temperature is the specified value or more or that the correction quantity of delay in the ignition timing in the knock control is larger than the specified value, the routine proceeds to step 120. At step 120, the count value of the counter, which is for measuring the duration of a state where the correction quantity of delay in the ignition timing is the specified value or less and where the actual cooling water temperature is nearly equal to the target water temperature, is decremented.

On the other hand, when it is determined in the step 119 that the absolute value of the difference between the actual cooling water temperature and the target water temperature is smaller than the specified value and that the correction quantity of delay in the ignition timing in the knock control is the specified value or less, the routine proceeds to step 121. At step 121, the count value of the counter is incremented. Subsequently, the routine proceeds to step 122 where it is determined whether the count value of the counter is larger than a specified value. When it is determined that the count value of the counter is larger than the specified value, the routine proceeds to step 123 where the correction quantity of water temperature is reset to zero and the post-warming-up cooling control is terminated and is returned to the post-warming-up normal control, and the count value of the counter is reset to zero.

In the present embodiment described above, when the knocking is detected before or after the warming-up of the engine 11 is completed, the cooling control is performed to control the water pump 12 so as to cool the engine 11 more strongly than when the knocking is not detected. Thus, the cylinder of the engine 11 is more strongly cooled than when the knocking is not detected, whereby the spontaneous ignition of air-fuel mixture to cause knocking can be restricted and hence knocking can be restricted. The knock restriction effect produced by the cooling control can restrict knocking in a state where the correction quantity of delay in the ignition timing is made smaller compared with the conventional operation. In the present operation, the correction quantity of delay in the ignition timing in the knock control can be reduced compared with the conventional operation. Therefore, the ignition timing can be brought close to the target ignition timing, or the correction quantity of delay in the ignition timing in the knock control can be made null to control the ignition timing to the target ignition timing. As a result, the torque can be effectively produced and hence the fuel consumption can be improved.

Moreover, in the present embodiment, the cooling control is terminated after the cooling control before or after the completion of warming-up is started and then a state, where the correction quantity of delay in the ignition timing in the knock control is the specified value (for example, zero) or less, continues for the specified time period. Thus, the cooling control can be terminated and returned to the normal control after it is ensured that the correction quantity of delay in the ignition timing in the knock control is made the specified value (for example, zero) or less so as to advance the ignition timing closely to the target ignition timing by the knock restriction effect produced by the cooling control.

In this regard, in the present embodiment described above, the cooling control is performed when knocking is detected, while a time delay is caused after the cooling control is started until the engine 11 is actually more strongly cooled than the operation where knocking is not detected. Thus, the knock restriction is in effect subsequent to the time delay.

In view of the present time delay, it is preferable to provide knock occurrence region determination means for determining whether the driving state of the engine 11 is in a driving region (knock occurrence region) and for performing the cooling control when it is determined that the driving state of the engine 11 is in the knock occurrence region. In the knock occurrence region, knocking may occur before or after the warming-up of the engine 11 is completed. In the present structure, at the timing when it is determined that the driving state of the engine 11 is in the knock occurrence region, the occurrence of knocking can be predicted and the cooling control can be started before knocking is actually detected. Hence, the knock restriction effect produced by the cooling control can be obtained in advance.

In the present structure, the knock occurrence region may be in advance set and stored in the ROM or the like of the ECU 21 on the basis of experiment data, design data, and the like. Alternatively, when knocking is detected while the engine is driven, the knock occurrence region may be learned on the basis of the driving state at that time, and the learned value of the knock occurrence region, which is stored in a writable non-volatile memory such as a backup RAM of the ECU 21, may be updated.

Moreover, in the embodiment described above, when knocking is detected before or after the warming-up of the engine 11 is completed, the cooling control is performed in which the water pump 12 is controlled so as to cool the engine 11 more strongly than when knocking is not detected. Alternatively, while the cooling control is performed when knocking is detected before the completion of warming-up, a channel for circulating the cooling water to only the radiator 13 from the engine 11 may be selected by the channel switching valve 18 to further enhance the effect of cooling the engine 11.

Alternatively, in place of the channel switching valve 18, a flow control valve (solenoid valve), which is capable of controlling the ratio of the flow of the cooling water flowing through the bypass channel 17 (bypass flow) to the flow of the cooling water flowing through the radiator 13 (radiator flow), may be provided. In this case, the ratio of the radiator flow may be increased by the flow control valve to further enhance the effect of cooling the engine 11 while the cooling control is performed when knocking is detected before or after the completion of warming-up of the engine 11.

Moreover, the present structure and method are not limited to the system provided with the channel switching valve 18 (solenoid valve) and the flow control valve (solenoid valve) to the cooling water circulation circuit 16. The present structure and method may be applied to a system provided with a thermostat operated automatically according to the cooling water temperature.

Furthermore, in the embodiment described above, the driving current of the water pump 12 is controlled to control the rotation speed of the water pump 12. The method of controlling the water pump 12 is not limited to the above description, but the driving voltage of the water pump 12 may be duty-controlled to control the rotation speed of the water pump 12.

The above processings such as calculations and determinations are not limited being executed by the ECU 21. The control unit may have various structures including the ECU 21 shown as an example.

The cooling water is an example of thermal medium for cooling the internal combustion engine. The thermal medium is not limited to water, and may be other fluid than water.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

The above embodiments are not limited to an analog circuitry including analog signal handling equipments configured to perform the processings such as the comparison, the amplification, and other operations by using analog quantities. For example, at least part of the signals in the circuit structures in the above embodiments may be converted to digital signals, and substantially the same processings such as the comparison, the amplification, and other operations may be performed using the converted digital signals by employing a microcomputer, a programmable logic circuit, and the like.

The above structures of the embodiments can be combined as appropriate. The above structure of the control apparatus of the internal combustion engine may be applied to a method for controlling the internal combustion engine.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A control apparatus for an internal combustion engine, the control apparatus comprising:
knock determination means for determining whether the internal combustion engine causes knocking;
knock control means for performing a knock control to correct an ignition timing on the basis of the determination;
a water pump configured to circulate cooling fluid of the internal combustion engine; and
pump control means for performing a cooling control to control the water pump so as to further cool the internal combustion engine in a detection state, where the knock determination means detects knocking, than in a non-detection state where the knock determination means does not detect knocking.

2. The control apparatus according to claim 1,
wherein the pump control means is configured to control the water pump so as to accelerate warming-up of the internal combustion engine in the non-detection state before completion of the warming-up of the internal combustion engine, and
the pump control means is configured to perform the cooling control in the detection state before completion of the warming-up of the internal combustion engine.

3. The control apparatus according to claim 1,
wherein the pump control means is configured to control the water pump so as to control temperature of cooling fluid in the vicinity of a target water temperature in the non-detection state after completion of warming-up of the internal combustion engine, and
the pump control means is configured to perform the cooling control in the detection state after completion of warming-up of the internal combustion engine.

4. The control apparatus according to claim 1, wherein the pump control means is configured to continue the cooling control until correction quantity of delay in the ignition timing becomes a predetermined delay or less in the knock control.

5. A control apparatus for an internal combustion engine, the control apparatus comprising:
knock determination means for determining whether the internal combustion engine causes knocking;
knock control means for performing a knock control to correct an ignition timing on the basis of the determination;
a water pump configured to circulate cooling fluid of the internal combustion engine;
region determination means for determining whether a driving state of the internal combustion engine is in a region where the internal combustion engine has a potential to cause knocking; and
pump control means for performing a cooling control to control the water pump so as to further cool the internal combustion engine in response to a determination of the region determination means that the driving state is in the region than when the driving state is out of the region.

6. A control apparatus for an internal combustion engine, the control apparatus comprising:
knock determination means for determining whether the internal combustion engine causes knocking;
knock control means for correcting an ignition timing of the internal combustion engine on the basis of the determination; and
cooling fluid control means for increasing an amount of cooling fluid fed to cool the internal combustion engine in response to determination of the knock determination means that the internal combustion engine causes knocking.

7. The control apparatus according to claim 6, further comprising:
a water pump configured to circulate the cooling fluid,
wherein the cooling fluid control means is configured to control the water pump to manipulate the amount of cooling fluid.

8. A control apparatus for an internal combustion engine, the control apparatus comprising:
knock determination means for determining whether the internal combustion engine causes knocking;
knock control means for correcting an ignition timing on the basis of the determination;
region determination means for determining whether a driving state of the internal combustion engine is in a region where the internal combustion engine causes knocking; and
cooling fluid control means for increasing an amount of cooling fluid fed to cool the internal combustion engine in response to determination of the region determination means determines that the driving state is in the region.

9. The control apparatus according to claim 8, further comprising:
a water pump configured to circulate the cooling fluid,
wherein the cooling fluid control means is configured to control the water pump to manipulate the amount of cooling fluid.

10. A method for controlling an internal combustion engine, the method comprising:
determining whether the internal combustion engine causes knocking;
correcting an ignition timing of the internal combustion engine on the basis of the determination; and
increasing an amount of cooling fluid fed to cool the internal combustion engine in response to a determination that the internal combustion engine causes knocking.

11. A method for controlling an internal combustion engine, the method comprising:
determining whether the internal combustion engine causes knocking;
correcting an ignition timing on the basis of the determination;
determining whether a driving state of the internal combustion engine is in a region where the internal combustion engine causes knocking; and
increasing an amount of cooling fluid fed to cool the internal combustion engine in response to a determination that the driving state is in the region.
